(19) United States
(12) Patent Application Publication
(10) Pub. No.: US 2022/0169081 A1
(43) Pub. Date: Jun. 2, 2022

(54) TIRE

(71) Applicant: Sumitomo Rubber Industries, Ltd., Hyogo (JP)

(72) Inventors: Takafumi NOGUCHI, Kobe-shi (JP); Yoshifumi KAWAGOE, Kobe-shi (JP); Yoshiaki KANEMATSU, Kobe-shi (JP)

(73) Assignee: Sumitomo Rubber Industries, Ltd., Hyogo (JP)

(21) Appl. No.: 17/455,791

(22) Filed: Nov. 19, 2021

(30) Foreign Application Priority Data
Dec. 1, 2020 (JP) 2020-199760

(51) Int. Cl. B60C 11/03; B60C 11/12

(52) U.S. Cl. CPC B60C 11/0332; B60C 2011/0358; B60C 2011/0348; B60C 11/1236

(57) ABSTRACT

A tire includes a tread portion including an outboard tread edge, an inboard tread edge, four circumferential grooves between the outboard and inboard tread edges, five land portions divided by the four circumferential grooves, and lateral grooves extending from the inboard tread edge to the crown land portion and terminating within the crown land portion. The four circumferential grooves include an inboard shoulder circumferential groove, an inboard crown circumferential groove, and an outboard crown circumferential groove. The five land portions include an inboard shoulder land portion, an inboard middle land portion, and a crown land portion between the inboard and outboard crown circumferential grooves. The crown land portion is provided with at least one crown sipe extending from the inboard crown circumferential groove or the outboard crown circumferential groove and terminating within the crown land portion, and crosses the axially center position of the crown land portion.

### RELATED APPLICATIONS

This application claims the benefit of foreign priority to Japanese Patent Application No. JP2020-199760, filed Dec. 1, 2020, which is incorporated by reference in its entirety.

### FIELD OF THE INVENTION

The present disclosure relates to a tire.

### BACKGROUND OF THE INVENTION

The Patent document 1 below discloses a pneumatic tire with an asymmetrical tread pattern having a designated mounting direction to a vehicle. The tread portion of the pneumatic tire is provided with inner lateral grooves extending to the tire equator from the inboard tread edge. Due to the inner lateral grooves, the pneumatic tire can drain water film between the crown land portion and the ground toward the vehicle inboard side.

### PATENT DOCUMENT

[Patent document 1] Japanese Unexamined Patent Application Publication 2013-100020

### SUMMARY OF THE INVENTION

Recent years, tires that can adapt to various road surface conditions have been required. Although the pneumatic tire of Patent Document 1 can exhibit high wet performance, there is room for improvement in improving snow performance.

On the other hand, tires with improved wet performance and snow performance also have the problem that traction performance on dry road conditions is likely to be impaired.

The present disclosure has been made in view of the above circumstances and has a major object to provide a tire capable of improving wet performance and snow performance while maintaining traction performance on dry roads.

In one aspect of the present disclosure, a tire includes a tread portion having a designated mounting direction to a vehicle, the tread portion including an outboard tread edge located outside of a vehicle when mounted on the vehicle, an inboard tread edge located inside of a vehicle when mounted on the vehicle, four circumferential grooves extending continuously in a tire circumferential direction between the outboard tread edge and the inboard tread edge, the four circumferential grooves including an inboard shoulder circumferential groove adjacent to the inboard tread edge, an inboard crown circumferential groove arranged between the inboard shoulder circumferential groove and a tire equator, and an outboard crown circumferential groove adjacent to the inboard crown circumferential groove such that the tire equator is located between the outboard crown circumferential groove and the inboard crown circumferential groove, five land portions divided by the four circumferential grooves, the five land portions including an inboard shoulder land portion including the inboard tread edge, an inboard middle land portion between the inboard shoulder circumferential groove and the inboard crown circumferential groove, and a crown land portion between the inboard crown circumferential groove and the outboard crown circumferential groove, and a plurality of lateral grooves extending at least from the inboard tread edge to the crown land portion and terminating within the crown land portion. The crown land portion is provided with at least one crown sipe extending from the inboard crown circumferential groove or the outboard crown circumferential groove and terminating within the crown land portion, and the at least one crown sipe crosses a center position in a tire axial direction of the crown land portion.

### BRIEF DESCRIPTION OF THE DRAWINGS

FIG. 1 is a development view of a tread portion of a tire according to an embodiment of the present disclosure;

FIG. 2 is an enlarged view of an inboard shoulder land portion, an inboard middle land portion and a crown land portion of FIG. 1;

FIG. 3 is a cross-sectional view taken along the line A-A of FIG. 2;

FIG. 4 is a cross-sectional view taken along the line B-B of FIG. 2;

FIG. 5 is a cross-sectional view taken along the line C-C of FIG. 2;

FIG. 6 is a cross-sectional view taken along the line D-D of FIG. 2;

FIG. 7 is a cross-sectional view taken along the line E-E of FIG. 2;

FIG. 8 is an enlarged view of an outboard middle land portion and an outboard shoulder land portion of FIG. 1;

FIG. 9 is an enlarged view of the inboard middle land portion according to another embodiment of the present disclosure;

FIG. 10 is a cross-sectional view taken along the line F-F of FIG. 9;

FIG. 11 is a cross-sectional view taken along the line G-G of FIG. 9;

FIG. 12 is a cross-sectional view taken along the line H-H of FIG. 9; and

FIG. 13 is a cross-sectional view taken along the line I-I of FIG. 9.

### DETAILED DESCRIPTION OF THE INVENTION

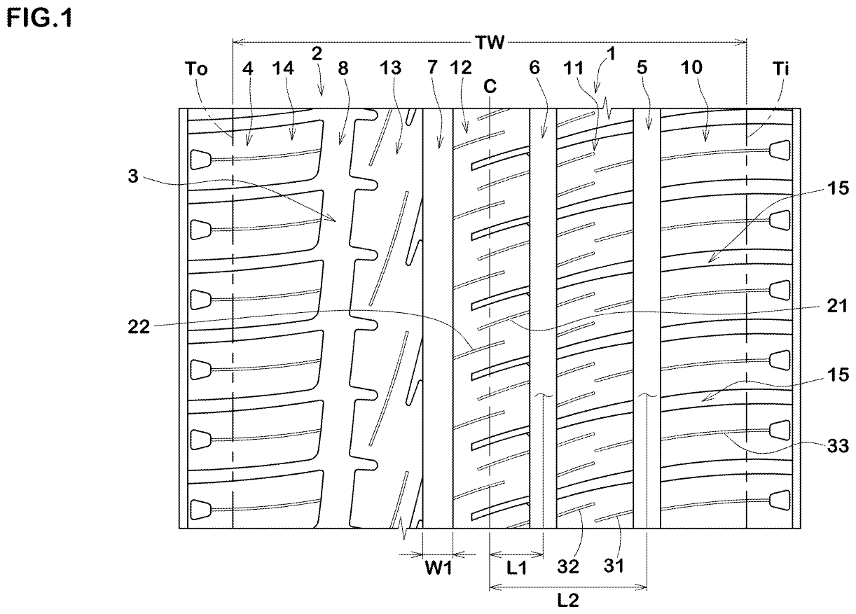

Hereinafter, an embodiment of the present disclosure will be described with reference to the drawings. FIG. 1 is a development view of a tread portion 2 of a tire 1 according to an embodiment. As illustrated in FIG. 1, the tire 1 according to the present embodiment, for example, is used as a pneumatic tire for all-season passenger cars, including driving on snowy roads. Note that the tire 1 according to the present disclosure is not limited to such an aspect.

The tire 1 according to the present disclosure includes the tread portion 2 having a designated mounting direction to a vehicle. The mounting direction to a vehicle, for example, is displayed in characters and/or marks on sidewall portions (not illustrated). Also, the tread portion 2, for example, is configured as an asymmetric pattern, which means that the tread pattern is not axisymmetric with respect to the tire equator C.

The tread portion 2 includes an outboard tread edge To located outside of a vehicle when mounted on the vehicle, and an inboard tread edge Ti located inside of a vehicle when mounted on the vehicle. The outboard tread edge To and the inboard tread edge Ti are the axial outermost edges of the ground contacting patch of the tire 1 which occurs under the condition such that the tire 1 under a normal state is grounded on a plane with a standard tire load at zero camber angles.

As used herein, when a tire is a pneumatic tire based on a standard, the “normal state” is such that the tire 1 is mounted onto a standard wheel rim with a standard pressure but loaded with no tire load. If a tire is not based on the standards, or if a tire is a non-pneumatic tire, the normal state is a standard state of use according to the purpose of use of the tire and means a state of no load. As used herein, unless otherwise noted, dimensions of portions of the tire are values measured under the normal state.

As used herein, the “standard wheel rim” is a wheel rim officially approved for each tire by standards organizations on which the tire is based, wherein the standard wheel rim is the “standard rim” specified in JATMA, the “Design Rim” in TRA, and the “Measuring Rim” in ETRTO, for example.

As used herein, the “standard pressure” is a standard pressure officially approved for each tire by standards organizations on which the tire is based, wherein the standard pressure is the “maximum air pressure” in JATMA, the maximum pressure given in the “Tire Load Limits at Various Cold Inflation Pressures” table in TRA, and the “Inflation Pressure” in ETRTO, for example.

As used herein, when a tire is a pneumatic tire based on a standard, the “standard tire load” is a tire load officially approved for each tire by the standards organization in which the tire is based, wherein the standard tire load is the “maximum load capacity” in JATMA, the maximum value given in the above-mentioned table in TRA, and the “Load Capacity” in ETRTO, for example. If a tire is not based on the standards, or it a tire is a non-pneumatic tire, the “standard tire load” refers to the load acting on the tire when the tire is under a standard mounted condition. The “standard mounted condition” is such that the tire is mounted to a standard vehicle according to the purpose of use of the tire, and the vehicle is stationary on a flat road surface while being able to run.

The tread portion 2 includes four circumferential grooves 3 extending continuously in the tire circumferential direction between the outboard tread edge To and the inboard tread edge Ti, and five land portions divided by four circumferential grooves 3.

The four circumferential grooves 3 include an inboard shoulder circumferential groove 5 adjacent to the inboard tread edge Ti, an inboard crown circumferential groove 6 arranged between the inboard shoulder circumferential groove 5 and the tire equator C, and an outboard crown circumferential groove 7 adjacent to the inboard crown circumferential groove 6 such that the tire equator C is located between the outboard crown circumferential groove 7 and the inboard crown circumferential groove 6. In addition, in the present embodiment, the tread portion 2 includes an outboard shoulder circumferential groove 8 between the outboard tread edge To and the outboard crown circumferential groove 7. The outboard shoulder circumferential groove 8 is located nearest to the outboard tread edge To among the circumferential grooves 3.

As the circumferential grooves 3, various shapes can be adopted, such as those extending straight and those extending in a zigzag shape.

A distance L1 in the tire axial direction from the tire equator C to the groove centerline of the outboard crown circumferential groove 7 or the groove centerline of the inboard crown circumferential groove 6 is in a range of from 5% to 15% of the tread width TW, for example. A distance L2 in the tire axial direction from the tire equator C to the groove centerline of the outboard shoulder circumferential groove 8 or the groove centerline of the inboard shoulder circumferential groove 5 is in a range of from 25% to 35% of the tread width TW, for example. Note that the tread width TW is a distance in the tire axial direction from the outboard tread edge To to the inboard tread edge Ti.

Preferably, a groove width W1 of the circumferential grooves 3 is equal to or more than 3 mm, at least. In some more preferred embodiments, a groove width W1 of the circumferential groove 3 is in a range of from 3.0% to 7.0% of the tread width TW.

The five land portions 4 include an inboard shoulder land portion 10 including at least the inboard tread edge Ti, an inboard middle land portion 11 between the inboard shoulder circumferential groove 5 and the inboard crown circumferential groove 6, and a crown land portion 12 between the inboard crown circumferential groove 5 and the outboard crown circumferential groove 6. In the present embodiment, the five land portions 4 further includes an outboard shoulder land portion 14 including the outboard tread edge To, and an outboard middle land portion 13 between the outboard shoulder circumferential groove 8 and the outboard crown circumferential groove 7.

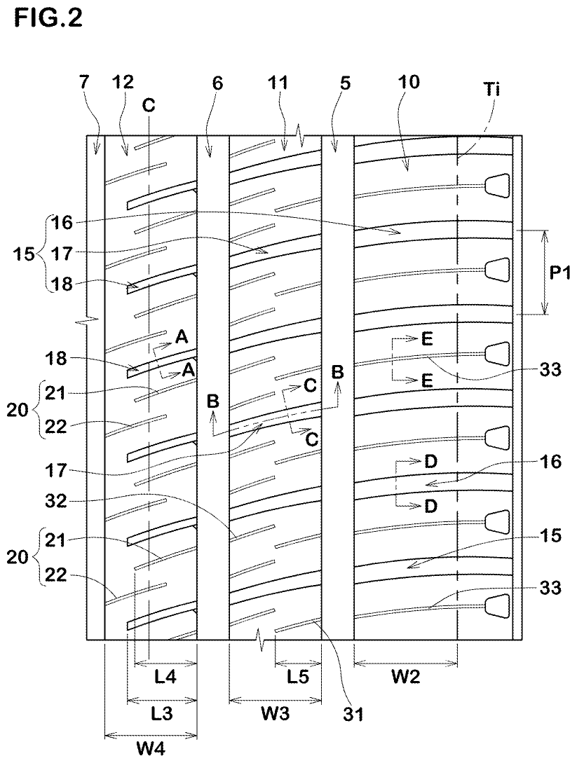

FIG. 2 illustrates an enlarged view of the inboard shoulder land portion 10, the inboard middle land portion 11 and the crown land portion 12. As illustrated in FIG. 2, the tread portion 2 is provided with a plurality of lateral grooves 15. The lateral grooves 15 traverse the inboard shoulder land portion 10, the inboard shoulder circumferential groove 5, the inboard middle land portion 11 and the inboard crown circumferential groove 6, and extend to the crown land portion 12 so as to terminate within the crown land portion 12. Due to the lateral grooves 15, drainage path extending from the crown land portion 12 to the inboard tread edge Ti can be ensured.

The crown land portion 12 is provided with at least one crown sipe 20. In the present embodiment, a plurality of crown sipes 20 is provided. The crown sipes 20 extend in the tire axial direction from the inboard crown circumferential groove 6 and/or the outboard crown circumferential groove 7, and terminate within the crown land portion 12 so as to have closed ends.

As used herein, “sipe” refers to an incision with a small width, and the width between a pair of adjacent inner walls thereof is equal to or less than 1.5 mm. Preferably, the width of the sipe is in a range of from 0.3 to 1.0 mm. In the present embodiment, the sipes open to a ground contact surface of the land portion so as to have the width within the above-mentioned range. A groove with a width of more than 1.5 mm, for example, may be connected to a bottom of the sipe (e.g., forming a flask shape).

In the present disclosure, the crown sipes 20 cross the center position in the tire axial direction of the crown land portion 12. In the present disclosure, by employing the above structure, the tire can exhibit superior wet performance and snow performance while maintaining traction performance on dry roads. The reason for this is presumed to be the following mechanism.

The above-mentioned lateral grooves 15 can exhibit high drainage and help to improve wet performance. In addition, the lateral grooves 15 can improve snow performance by forming horizontally long snow columns and providing a large snow-column shearing force when driving on snow. In addition, since the crown sipes 20 are terminate within the crown land portion 12, rigidity of the crown land portion 12 can be maintained, resulting in maintaining traction performance on dry roads. In addition, the crown sipes 20 that cross the center position of the crown land portion 12 can exert large edge effect and can enhance wet performance and snow performance. It is presumed that due to such a mechanism, the tire 1 according to the present disclosure can exhibit excellent wet performance and snow performance while maintaining traction performance on dry roads.

Hereinafter, a more detailed configuration of the present embodiment will be described. Note that each configuration described below shows a specific aspect of the present embodiment. Thus, the present disclosure can exert the above-mentioned effects even if the tire does not include the configuration described below. Further, if any one of the configurations described below is applied independently to the tire of the present disclosure having the above-mentioned characteristics, the performance improvement according to each additional configuration can be expected. Furthermore, when some of the configurations described below are applied in combination, it is expected that the performance of the additional configurations will be improved.

The lateral grooves 15, for example, extend beyond the inboard tread edge Ti outward in the tire axial direction. Thus, the inboard shoulder land portion 10 is divided into a plurality of blocks. Such lateral grooves 15 can exhibit superior drainage performance. In addition, the lateral grooves 15 include shoulder groove portions 16 arranged on the inboard shoulder land portion 10, middle groove portions 17 arranged on the inboard middle land portion 11, and crown groove portions 18 arranged on the crown land portion 12. The lateral grooves 15 each form a substantially one drainage path by the shoulder groove portion 16, the middle groove portion 17 and the crown groove portion 18. For example, virtual regions that extend from the respective shoulder groove portions 16 along a length direction thereof toward the tire equator C may overlap with groove widths at ends of the respective middle groove portions 17 on the inboard tread edge side Ti. In addition, virtual regions that extend from the respective middle groove portions 17 along a length direction thereof toward the tire equator C may overlap with groove widths at ends of the respective crown groove portions 18 on the inboard tread edge side Ti.

The virtual regions of the shoulder groove portions 16 preferably overlap 50% or more, more preferably 80% or more of the groove widths at the respective ends of the middle groove portions 17. Similarly, the virtual regions of the middle groove portions 17 preferably overlap 50% or more, more preferably 80% or more of the groove widths at the respective ends of the crown groove portions 18. In some more preferred embodiments, the virtual region of the shoulder groove portions 16 may overlap 100% of the groove widths of the respective ends of the middle groove portions 17, and the virtual regions of the middle groove portions 17 may overlap 100% of the groove widths of the respective ends of the crown groove portions 18. Thus, wet performance can be improved for sure.

It is preferable that a groove width of the lateral grooves 15 reduces toward the outboard tread edge To (shown in FIG. 1, and the same applied below). In other words, a groove width of the middle groove portions 17 is smaller than a groove width of the shoulder groove portions 16, and a groove width of the crown groove portions 18 is smaller than the groove width of the middle groove portions 17. A groove width of the shoulder groove portions 16, for example, is in a range of from 4.4 to 5.0 mm. A groove width of the middle groove portions 17, for example, is in a range of from 3.3 to 4.4 mm. A groove width of the crown groove portions 18, for example, is equal to or less than 3.3 mm. Such lateral grooves 15 can improve steering stability on dry roads (hereinafter, may simply referred to as “steering stability”), wet performance and snow performance in a well-balanced manner.

The lateral grooves 15, for example, are inclined with respect to the tire axial direction. An angle of the lateral grooves 15 with respect to the tire axial direction, for example, is in a range of from 5 to 25 degrees. As a more preferred embodiment, an angle of the lateral grooves 15 with respect to the tire axial direction increases toward the outboard tread edge To. Such lateral grooves 15 can also provide snow-column shearing force to the tire axial direction when driving on snow.

Preferably, a pitch length P1 in the tire circumferential direction of the plurality of lateral grooves 15 is smaller than a width W2 in the tire axial direction of the inboard shoulder land portion. Specifically, the pitch length P1 is in a range of from 70% to 95% of the width W2 of the inboard shoulder land portion 10. In some more preferred embodiments, the pitch length P1 of the lateral grooves 15 is smaller than a width W3 in the tire axial direction of the inboard middle land portion 11 and a width W4 in the tire axial direction of the crown land portion 12. Such an arrangement of lateral grooves 15 can help to reliably improve wet performance and snow performance. As used herein, a pitch length means a distance in the tire circumferential direction between the groove center lines of two directly adjacent grooves.

The crown groove portions 18, for example, cross the center position in the tire axial direction of the crown land portion 12. A length L3 in the tire axial direction of the crown groove portions 18, for example, is in a range of from 60% to 90% of the width W4 in the tire axial direction of the crown land portion 12. This may improve traction performance on dry roads, wet performance and snow performance in a well-balanced manner.

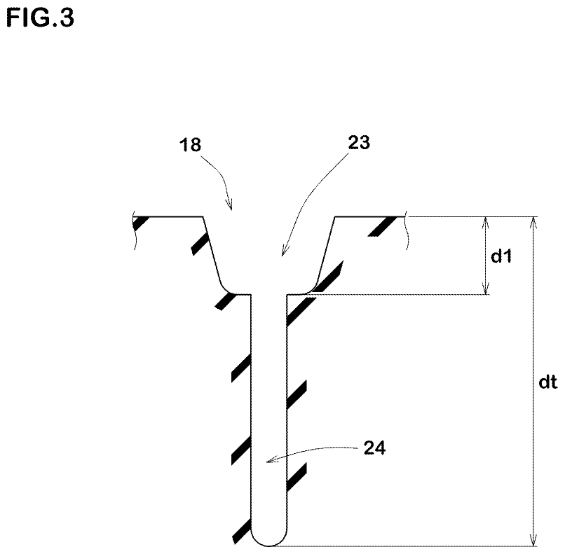

FIG. 3 illustrates a cross-sectional view taken along the line A-A of FIG. 2. As illustrated in FIG. 3, the crown groove portions 18 each include an outer portion 23 opening to a ground contact surface of the crown land portion 12 having a width greater than 1.5 mm, and a sipe portion 24 having a width equal to or less than 1.5 mm and extending inwardly from a bottom of the outer portion 23. A depth d1 of the outer portion 23, for example, is equal to or less than 2.5 mm, preferably of from 1.0 to 2.0 mm. In addition, a depth d1 of the outer portion 23 is in a range of from 15% to 30% of the entire depth dt of the crown groove portion 18. Such crown groove portions 18 can maintain rigidity of the crown land portion 12. Further, the crown groove portions 18, during wet driving, can guide the water therein smoothly to the middle groove portions 17 (shown in FIG. 2) as the contact pressure changes.

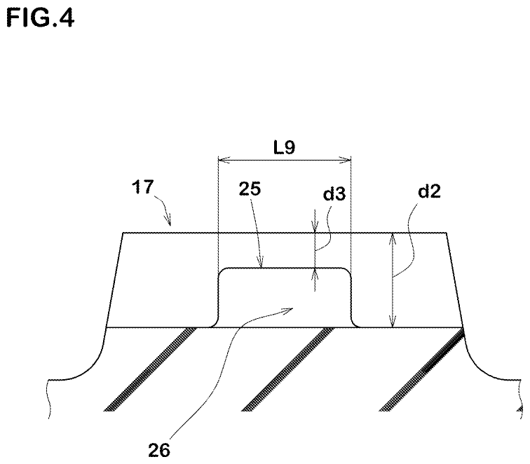

FIG. 4 illustrates a cross-sectional view taken along the line B-B of FIG. 2. As illustrated in FIG. 4, it is preferable that at least one of the middle groove portions 17 is provided with a tie-bar 25 in which a bottom thereof is locally raised. The tie-bar 25 according to the present embodiment is provided in the central region when the middle groove portion 17 is equally divided into three portions in the length direction in a tread plan view. Such a tie-bar 25 can help maintain stiffness of the inboard middle land portion 11 and enhance traction performance on dry roads.

In order to exhibit the above-mentioned effect while maintaining wet performance, it is preferable that a length L9 in the tire axial direction of the tie-bar 25 is in a range of from 25% to 40% of the width W3 (shown in FIG. 2) in the tire axial direction of the inboard middle land portion 11. Note that when a length of the tie-bar 25 changes in the tire radial direction, the length shall be measured at the center position in the tire radial direction of the tie-bar 25. The minimum depth d3 of the portion where the tie-bar 25 is provided is in a range of from 30% to 50% of the maximum depth d2 of the middle groove portion 17, for example.

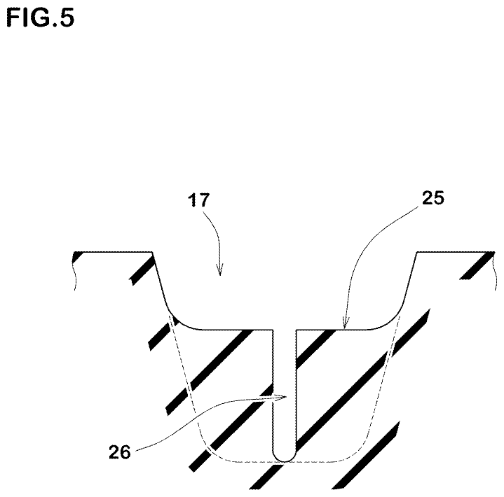

FIG. 5 illustrates a cross-sectional view of taken along the line C-C of FIG. 2, as a cross-section of the tie-bar 25. As illustrated in FIG. 5, it is preferable that the tie-bar 25 is provided with a groove bottom sipe 26 that opens to an outer surface of the tie-bar 25. The groove bottom sipe 26, for example, extends over the entire length of the tie-bar 25 in the longitudinal direction of the middle groove portions 17. Such a groove bottom sipe 26 can help to maintain drainage of the middle groove portion 17.

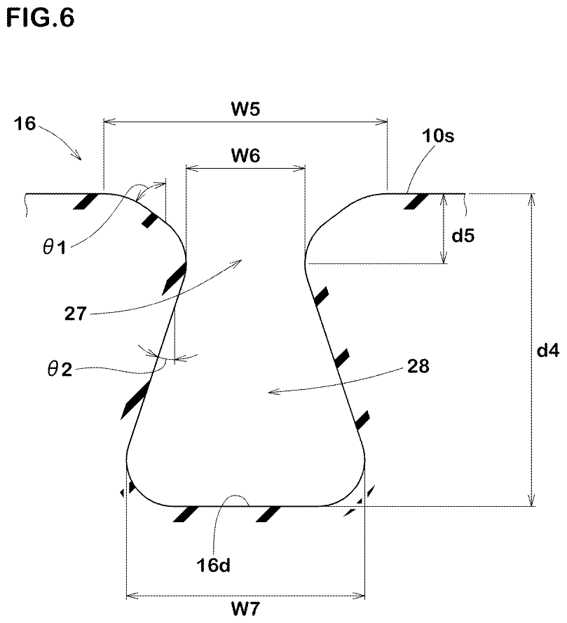

FIG. 6 illustrates a cross-sectional view taken along the line D-D of FIG. 2. As illustrated in FIG. 6, the shoulder groove portions 16 each include a minimum portion 27 where a groove width of the shoulder groove portion 16 has a minimum between a ground contact surface 10s of the inboard shoulder land portion 10 and a bottom 16d of the shoulder groove portion. This feature can mitigate deterioration of wet performance due to the wear of the tread portion 2.

A maximum depth d4 of the shoulder groove portions 16, for example, is in a range of from 70% to 90% of a maximum depth of the inboard shoulder circumferential groove 5. In addition, a depth d5 from the ground contact surface 10s to the minimum portion 27, for example, is smaller than a 50% of the maximum depth d4 of the shoulder groove portions 16. The depth d5 of the minimum portion 27 is preferably in a range of from 10% to 40% of the depth d1. As a result, the minimum portion 27 is exposed to the ground contact surface 10s when the wear of the tread portion 2 progresses moderately, and the deterioration of wet performance due to the subsequent wear of the tread portion 2 can be suppressed.

A groove width W6 of the minimum portion 27, for example, is in a range of from 30% to 60%, preferably 40% to 50%, of a groove width W5 of the shoulder groove portion 16 at the ground contact surface 10s. Such a minimum portion 27 can help to maintain a balance between dry performance and wet performance.

In a region from the ground contact surface 10s to the minimum portion 27, an angle θ1 of a pair of groove walls of each shoulder groove portion 16 with respect to the tire normal, for example, is in a range of 40 to 60 degrees. As a result, at the start of tire use, the groove walls located outwardly in the tire radial direction of the minimum portion 27 may come into contact with the ground appropriately as the contact pressure increases. In other words, the groove walls located outwardly in the tire radial direction of the minimum portion 27 can play the role of a chamfer, which may improve traction performance and braking performance.

Each shoulder groove portion 16 further includes a main portion 28 located inwardly in the tire radial direction of the minimum portion 27. A maximum groove width W7 of the main portion 28 is equal to or smaller than the above-mentioned groove width W5 of the shoulder groove portion 16 at the ground contact surface 10s. The maximum groove width W7 of the main portion 28, for example, is in a range of 50% to 100%, preferably 70% to 100%, of the groove width W5 of the shoulder groove portions 16 at the ground contact surface 10s. Thus, sufficient wet performance can be exhibited when the tread portion 2 is worn to the extent that the vicinity of the maximum groove width W7 is exposed.

The main portion 28 includes a portion whose groove width increases inwardly in the tire radial direction. An angle θ2 of this portion with respect to the tire normal is smaller than the angle θ1, for example, and is preferably in a range of 15 to 25 degrees.

As illustrated in FIG. 2, the crown sipes 20 include a plurality of first crown sipes 21 and a plurality of second crown sipes 22. The first crown sipes 21 extend in the tire axial direction from the inboard crown circumferential groove 6 and terminate within the crown land portion 12. The second crown sipes 22 extend in the tire axial direction from the outboard crown circumferential groove 7 and terminate within the crown land portion 12. The first crown sipes 21 and the second crown sipes 22, for example, are arranged alternately in the tire circumferential direction. As a preferred embodiment, in the present embodiment, two crown sipes consisting of one of the first crown sipes 21 and one of the second crown sipes 22 are arranged between the adjacent two crown groove portions 18. Note that the present disclosure is not limited to such an aspect.

In the entire crown land portions 12, the total number of the plurality of second crown sipes 22 is equal to or less than the total number of the plurality of first crown sipes 21, for example. As a preferred embodiment, in the present embodiment, the total number of the first crown sipes 21 equals to the total number of the second crown sipes. Thus, uneven wear of the crown land portion 12 can be suppressed.

In order to improve steering stability on dry roads and wet performance in a well-balanced manner, a length L4 in the tire axial direction of the crown sipes 20 is smaller than a length L3 in the tire axial direction of the crown groove portions 18. Specifically, the length L4 of the crown sipes 20 is preferably in a range of from 55% to 80% of the width W4 in the tire axial direction of the crown land portion 12.

A length in the tire axial direction of the first crown sipes 21 is smaller than the length L3 in the tire axial direction of the crown groove portions 18. In addition, the length in the tire axial direction of the first crown sipes 21 is equal to or more than a length in the tire axial direction of the second crown sipes 22.

The first crown sipes 21 and the second crown sipes 22, for example, are inclined in the same direction with respect to the tire axial direction as the crown groove portions 18, and in some preferred embodiments, the angle difference between them may be 5 degrees or less. An angle of the first crown sipes 21 and the second crown sipes 22 with respect to the tire axial direction, for example, is in a range of 15 to 25 degrees. As a more preferred embodiment, in the present embodiment, the first crown sipes 21, the second crown sipes 22, and the crown groove portions 18 extend in parallel with each other. Thus, uneven wear of the crown land portion 12 can be suppressed.

The inboard middle land portion 11 is provided with a plurality of first middle sipes 31 and a plurality of second middle sipes 32. The first middle sipes 31 extend in the tire axial direction from the inboard shoulder circumferential groove 5 and terminate within the inboard middle land portion 11. The second middle sipes 32 extend in the tire axial direction from the inboard crown circumferential groove 6 and terminate within the inboard middle land portion 11. The first middle sipes 31 and the second middle sipes 32 can exhibit edge effect while maintaining sufficient rigidity of the inboard middle land portion 11.

In some preferred embodiments, the total number of the plurality of second middle sipes 32 is greater than the total number of the plurality of first middle sipes 31. Specifically, the total number of the second middle sipes 32 is in a range of from 1.5 to 2.5 times of the total number of the first middle sipes 31. As a result, end portions of the middle groove portions 17 on the tire equator C side tend to deform easily as compared to end portions thereof on the inboard tread edge Ti side. Thus, when driving on wet roads, the middle groove portions 17 can deform such that the water inside thereof is drained to the inboard tread edge Ti side, improving wet performance further.

A length L5 in the tire axial direction of the first middle sipes 31, for example, is in a range of 40% to 60% of the width W3 in the tire axial direction of the inboard middle land portion 11. The same applies to the second middle sipes 32. With this, the above effects can further be exhibited easily.

The first middle sipes 31 and the second middle sipes 32, for example, are inclined in the same direction with respect to the tire axial direction as the middle groove portions 17, and in some preferred embodiment, the angle difference between them may be 5 degrees or less. An angle of the first middle sipes 31 and the second middle sipes 32 with respect to the tire axial direction, for example, is in a range of from 10 to 20 degrees. As a more preferred embodiment, in the present embodiment, the first middle sipes 31, the second middle sipes 32, and the middle groove portions 17 extend in parallel with each other. Thus, uneven wear of the inboard middle land portion 11 can be suppressed.

The inboard shoulder land portion 10 is provided with a plurality of inboard shoulder sipes 33. The inboard shoulder sipes 33 extend outwardly in the tire axial direction from the inboard shoulder circumferential groove 5, and traverse the inboard tread edge Ti.

The inboard shoulder sipes 33, for example, are inclined in the same direction with respect to the tire axial direction as the shoulder groove portions 16, and in some preferred embodiments, the angle difference between them is 5 degrees or less. An angle of the inboard shoulder sipes 33 with respect to the tire axial direction, for example, is in a range of from 5 to 15 degrees. As a more preferred embodiment, in the present embodiment, the inboard shoulder sipes 33 and the shoulder groove portions 16 extend in parallel with each other. With this, uneven wear of the inboard shoulder land portion 10 can be suppressed.

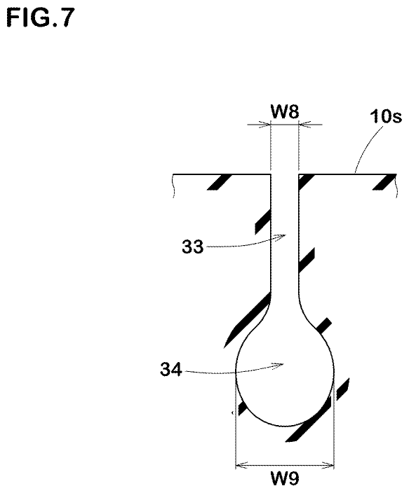

FIG. 7 illustrates a cross-sectional view taken along the line E-E of FIG. 2. As illustrated in FIG. 7, each inboard shoulder sipe 33 extends inwardly in the tire radial direction from a ground contact surface 10s of the inboard shoulder land portion 10 with a width W8 equal to or less than 1.5 mm. In addition, an internal groove 34 that has a larger width than that of the inboard shoulder sipe 33 is communicated with a radially inner end of the inboard shoulder sipe 33. The maximum groove width W9 of the internal groove 34 is preferably in a range of 2.0 to 4.0 times of the width W8 of the inboard shoulder sipe 33. Such an internal groove 34 can help to maintain wet performance of the tire even if the tread portion 2 is worn.

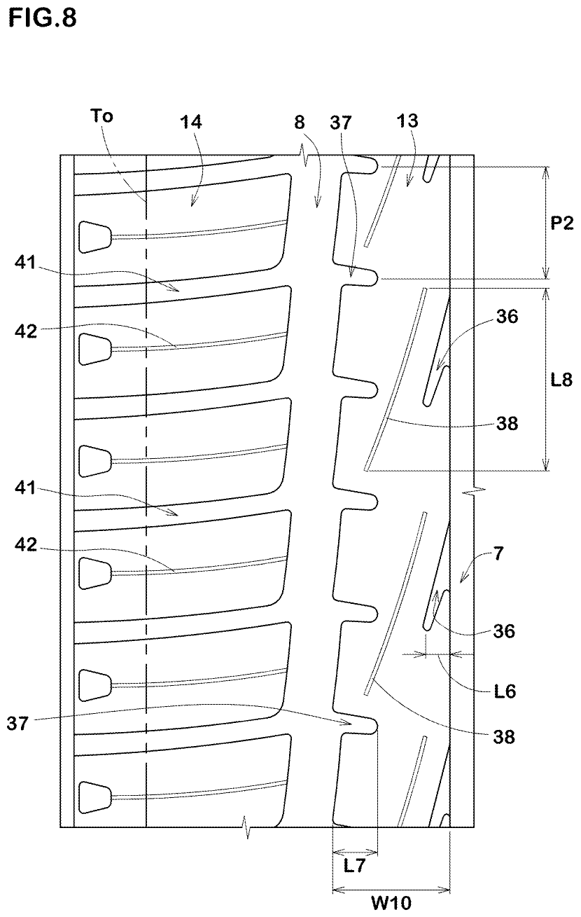

FIG. 8 illustrates an enlarged view of the outboard middle land portion 13 and the outboard shoulder land portion 14. As illustrated in FIG. 8, the outboard middle land portion 13 is provided with a plurality of first middle blind grooves 36, a plurality of second middle blind grooves 37 and a plurality of decorative sipes 38.

The first middle blind grooves 36 extends from the outboard crown circumferential groove 7 and terminate within the outboard middle land portion 13. The first middle blind grooves 36, for example, terminate so as not to traverse the center position in the tire axial direction of the outboard middle land portion 13. A length L6 in the tire axial direction of the first middle blind grooves 36, for example, is in a range of 15% to 25% of a width W10 in the tire axial direction of the outboard middle land portion 13. Such first middle blind grooves 36 can improve steering stability and wet performance in a well-balanced manner.

The first middle blind grooves 36, for example, are inclined in the same direction with respect to the tire axial direction as the lateral grooves 15. An angle of the first middle blind grooves 36 with respect to the tire axial direction is preferably greater than a maximum angle of the lateral grooves 15 with respect to the tire axial direction. An angle of the first middle blind grooves 36 with respect to the tire axial direction, for example, is in a range of 70 to 80 degrees.

From a similar point of view, the second middle blind grooves 37 extend from the outboard shoulder circumferential groove 8 and terminate within the outboard middle land portion 13. The second middle blind grooves 37, for example, terminate so as not to traverse the center position in the tire axial direction of the outboard middle land portion 13. A length L7 in the tire axial direction of the second middle blind grooves 37, for example, is in a range of from 30% to 45% of the width W10 in the tire axial direction of the outboard middle land portion 13.

The second middle blind grooves 37, for example, are inclined in the opposite direction to the lateral grooves 15 with respect to the tire axial direction. An angle of the second middle blind grooves 37 with respect to the tire axial direction is smaller than an angle of the first middle blind grooves 36 with respect to the tire axial direction. The angle of second middle blind grooves 37 with respect to the tire axial direction, for example, is in a range of 5 to 15 degrees.

The decorative sipes 38 has an opening width equal to or less than 1.5 mm on the ground contact surface of the land portion and a depth of from 0.5 to 1.5 mm. Such decorative sipes 38 can offer superior edge effect at the start of tire use and can improve snow performance.

Each decorative sipe 38, for example, each have both closed ends that are terminated within the outboard middle land portion 13. In addition, the decorative sipes 38 are inclined with respect to the tire axial direction in the same direction as the first middle blind grooves 36. An angle of the decorative sipes 38 with respect to the tire axial direction, for example, is in a range of 60 to 80 degrees.

The decorative sipes 38, for example, traverse the center position in the tire axial direction of the outboard middle land portion 13. A length L8 in the tire circumferential direction of the decorative sipes 38, for example, is in a range of 1.3 to 2.0 times of a pitch length P2 in the tire circumferential direction of the second middle blind grooves 37. Such decorative sipes 38 can exhibit powerful friction force in the tire axial direction when driving on snow.

The outboard shoulder land portion 14 is provided with a plurality of outboard shoulder lateral grooves 41 and a plurality of outboard shoulder sipes 42. The outboard shoulder lateral grooves 41 have substantially the same configuration as the shoulder groove portions 16 (shown in FIG. 2). Thus, the configuration of the shoulder groove portions 16 described above can be applied to the outboard shoulder lateral grooves 41. In addition, the outboard shoulder sipes 42 have substantially the same configuration as the inboard shoulder sipes 33 (shown in FIG. 2). Thus, the configuration of the inboard shoulder sipes 33 described above can be applied to the outboard shoulder sipes 42.

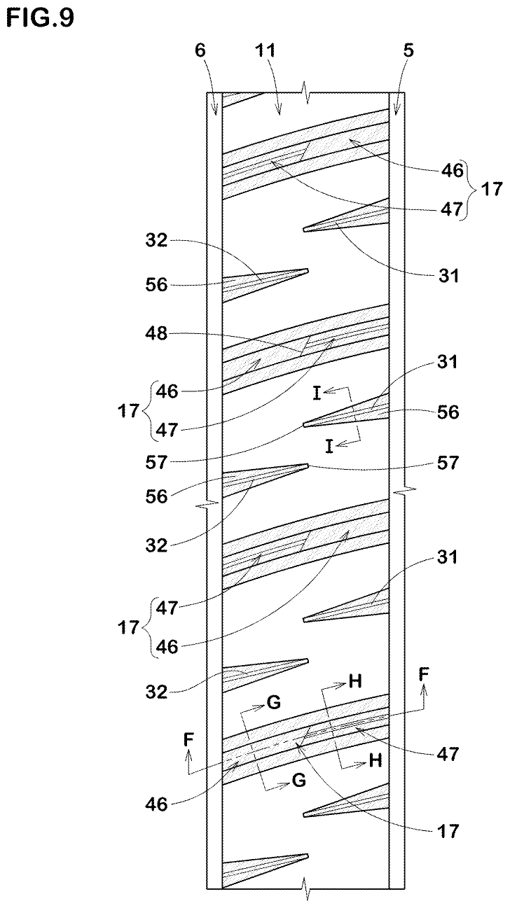

FIG. 9 illustrates an enlarged view of the inboard middle land portion 11 in accordance with another embodiment of the present disclosure. In this embodiment, the configurations already described are applied to the configurations other than the inboard middle land portion 11. In FIG. 9, the elements that have already described are given the same reference numerals as those described above. The above configuration can be applied to elements not specifically explained. Further, in FIG. 9, dots are applied to openings of the middle groove portions 17, the first middle sipes 31 and the second middle sipes 32 provided in the inboard middle land portion 11. Furthermore, in FIG. 9, the outline of the inside of each middle groove portion 17 that can be recognized in the tread plane view is shown.

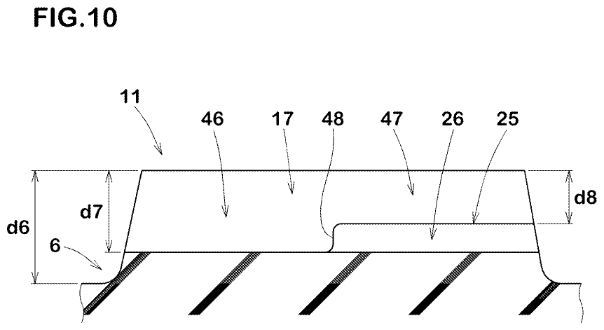

FIG. 10 illustrates a cross-sectional view taken along the line F-F of FIG. 9. As illustrated in FIG. 10, each middle groove portion 17 according to this embodiment includes a first portion 46 and a second portion 47 being provided with a tie-bar 25 in which a bottom thereof is locally raised. A depth d7 of the first portion 46, for example, is in a range of 65% to 80% of a depth d6 of the inboard crown circumferential groove 6. A depth d8 of the second portion 47 (i.e., a depth from the ground contact surface of the land portion to an outer surface of the tie-bar 25), for example, is in a range of 55% to 75% of the depth d7 of the first portion 46. Such a middle groove portion 17 with the tie-bar 25 can help to improve traction performance on dry roads while maintaining sufficient rigidity of the inboard middle land portion 11.

Preferably, a boundary 48 between the first portion 46 and the second portion 47, for example, is located in the central region when the middle groove portion 17 is divided into three equal parts in the tire axial direction. This makes it possible to improve traction performance on dry roads, wet performance and snow performance in a well-balanced manner. Further, as illustrated in FIG. 9, in a tread plan view, each boundary 48 of this embodiment extends at an angle with respect to the direction orthogonal to the middle groove portions 17. As a result, uneven wear near the boundary 48 of the inboard middle land portion 11 can be suppressed.

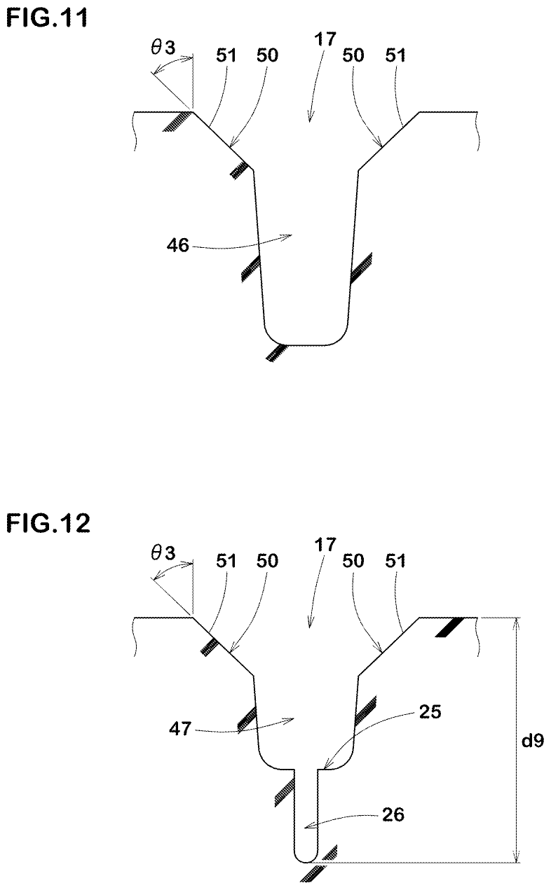

FIG. 11 illustrates a cross-sectional view taken along the line G-G of FIG. 9. FIG. 12 illustrates a cross-sectional view taken along the line H-H of FIG. 9. As illustrated in FIG. 11 and FIG. 12, each middle groove portion 17 according to this embodiment includes the first portion 46 and the second portion 47 that are provided with chamfer portions 50. The chamfer portions 50 include a pair of inclined surfaces 51 between a ground contact surface of the land portion and a pair of groove-wall main portions of the middle groove portion 17. An angle 03 of the inclined surfaces 51 with respect to the tire normal, for example, is in a range of 40 to 60 degrees. Such chamfer portions 50 can be helpful to suppress uneven wear of the inboard middle land portion 11.

As illustrated in FIG. 12, the second portion 47 is provided with the groove bottom sipe 26 that opens on an outer surface of the tie-bar 25. The groove bottom sipe 26, for example, traverse the tie-bar 25 entirely in the longitudinal direction of the middle groove portions 17. Such a groove bottom sipe 26 can be helpful to maintain drainage of each middle groove portions 17.

In each second portion 47, an entire depth d9 from the ground contact surface of the land portion to a bottom of the groove bottom sipe 26 is preferably in a range of 80% to 120% of the depth d7 of the first portion 46 (shown in FIG. 10). In some more preferred embodiments, the entire depth d9 equals to the depth d7 of the first portion 46. Thus, the difference in rigidity between the periphery of the first portion 46 and the periphery of the second portion 47 becomes smaller, and uneven wear of the inboard middle land portion 11 can be suppressed.

As illustrated in FIG. 9, in this embodiment, the inboard middle land portion 11 is provided with: at least one of the middle groove portions 17 which includes the second portion 47 located on the inboard shoulder circumferential groove 5 side than the first portion 46; and at least one of the middle groove portions 17 which includes the second portion 47 located on the inboard crown circumferential groove 6 side than the first portion 46; and which are arranged alternately in the tire circumferential direction. Thus, uneven wear of the inboard middle land portion 11 can be suppressed.

In this embodiment, one of the first middle sipes 31 and one of the second middle sipes 32 are arranged between the adjacent two middle groove portions 17. Note that the present disclosure is not limited to such an aspect.

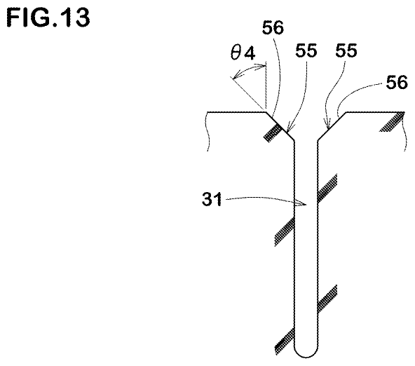

FIG. 13 illustrates a cross-sectional view taken along the line I-I of FIG. 9. As illustrated in FIG. 13, the first middle sipes 31 and the second middle sipes 32 according to this embodiment may include chamfer portions 55. Each chamfer portion 55 includes an inclined surface 56 between a ground contact surface of the land portion and an inner wall of the sipe which extends along the tire radial direction. An angle θ4 of the inclined surface 56 with respect to the tire normal, for example, is in a range of 40 to 60 degrees. Such a chamfer portion 55 can be helpful to suppress uneven wear of the inboard middle land portion 11.

As illustrated in FIG. 9, it is preferable that a width of the inclined surface 56 of the first middle sipes 31 and a width of the inclined surface 56 of the second middle sipes 32 decrease continuously toward terminal ends 57 of the respective sipes. Thus, the ground pressure acting on the inboard middle land portion 11 can become uniform, and traction performance on dry roads can improve.

While tires according to one or more embodiments of the present disclosure have been described in detail above, the present disclosure is not limited to the specific embodiment described above, and may be modified to various embodiments.

### EXAMPLE

Tires having a size of 275/40ZR20 with a basic tread pattern shown in FIG. 1 were prepared based on the specifications in Table 1. As a comparative example, a tire was also prepared in which the first crown sipes and the second crown sipes do not cross the center position in the tire axial direction of the crown land portion. The comparative example tire has substantially the same configuration as the tire shown in FIG. 1 except for the above configuration. For each test tire, traction performance on dry road, wet performance and snow performance were tested. The common specifications and test methods for each test tire are as follows.
Rim size: 20×9.5J
Tire inner pressure: 250 kPa (all wheels)
Test vehicle: Rear-drive vehicle with 3500 cc displacement
Tire mounted location: all wheels

### Traction Performance Test:

Traction performance when driving on a dry road with the above test vehicle was evaluated by the driver's sensuality. The test results are shown using a score with the traction performance of the comparative example as 100. The larger the value, the better the traction performance.

### Wet Performance Test:

Wet performance when driving on a wet road with the above test vehicle was evaluated by the driver's sensuality. The test results are shown using a score with the wet performance of the comparative example as 100. The larger the value, the better the wet performance.

### Snow Performance Test:

Snow performance when driving on a snowy road with the above test vehicle was evaluated by the driver's sensuality. The test results are shown using a score with the snow performance of the comparative example as 100. The larger the value, the better the snow performance.

The test results are shown in Table 1.

TABLE 1

| | Ref. | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| Length L4 of crown sipes/width W4 of | 35 | 66 | 55 | 60 | 70 | 80 | 66 | 66 | 66 | 66 |
| crown land portion (%) | | | | | | | | | | |
| Length L3 of crown groove portions/ | 75 | 75 | 75 | 75 | 75 | 75 | 60 | 70 | 80 | 90 |
| width W4 of crown land portion (%) | | | | | | | | | | |
| Traction performance on dry road (score) | 100 | 100 | 100 | 100 | 100 | 99 | 102 | 101 | 99 | 98 |
| Wet performance (score) | 100 | 107 | 104 | 106 | 107 | 108 | 107 | 107 | 108 | 108 |
| Snow performance (score) | 100 | 108 | 104 | 107 | 108 | 108 | 108 | 108 | 108 | 109 |

As shown in Table 1, the tires of the examples exhibited excellent values such as wet performance of 104 to 108 points and snow performance of 104 to 109 points, while traction performance on dry road was maintained at 98 to 102 points. In other words, it is confirmed that the tires according to the present disclosure can exhibit excellent wet performance and snow performance while maintaining traction performance on dry roads.

### [Additional Notes]

This disclosure includes the following contents.

### [Clause 1]

A tire comprising:
a tread portion having a designated mounting direction to a vehicle, the tread portion comprising:
an outboard tread edge located outside of a vehicle when mounted on the vehicle;
an inboard tread edge located inside of a vehicle when mounted on the vehicle;
four circumferential grooves extending continuously in a tire circumferential direction between the outboard tread edge and the inboard tread edge, the four circumferential grooves comprising
   an inboard shoulder circumferential groove adjacent to the inboard tread edge,
   an inboard crown circumferential groove arranged between the inboard shoulder circumferential groove and a tire equator, and
   an outboard crown circumferential groove adjacent to the inboard crown circumferential groove such that the tire equator is located between the outboard crown circumferential groove and the inboard crown circumferential groove;
five land portions divided by the four circumferential grooves, the five land portions comprising
   an inboard shoulder land portion including the inboard tread edge,
   an inboard middle land portion between the inboard shoulder circumferential groove and the inboard crown circumferential groove, and
   a crown land portion between the inboard crown circumferential groove and the outboard crown circumferential groove; and
a plurality of lateral grooves extending at least from the inboard tread edge to the crown land portion and terminating within the crown land portion,
wherein
the crown land portion is provided with at least one crown sipe extending from the inboard crown circumferential groove or the outboard crown circumferential groove and terminating within the crown land portion, and
the at least one crown sipe crosses a center position in a tire axial direction of the crown land portion.

### [Clause 2]

The tire according to clause 1, wherein
the plurality of lateral grooves comprises crown groove portions arranged on the crown land portion,
the at least one crown sipe comprises a plurality of first crown sipes extending from the inboard crown circumferential groove, and
a length in the tire axial direction of the plurality of first crown sipes is smaller than a length in the tire axial direction of the crown groove portions.

### [Clause 3]

The tire according to clause 2, wherein
the at least one crown sipe comprises a plurality of second crown sipes extending from the outboard crown circumferential groove, and
the length in the tire axial direction of the plurality of first crown sipes is equal to or greater than a length in the tire axial direction of the plurality of second crown sipes.

### [Clause 4]

The tire according to clause 3, wherein
the plurality of first crown sipes and the plurality of second crown sipes are arranged alternately in the tire circumferential direction.

### [Clause 5]

The tire according to clause 3 or 4, wherein
a total number of the plurality of second crown sipes is equal to or less than a total number of the plurality of first crown sipes.

### [Clause 6]

The tire according to any one of clauses 1 to 5, wherein
the plurality of lateral grooves comprises crown groove portions arranged on the crown land portion,
the crown groove portions each comprises an outer portion opening to a ground contact surface of the crown land portion having a width greater than 1.5 mm, and a sipe portion having a width equal to or less than 1.5 mm and extending inwardly from a bottom of the outer portion.

### [Clause 7]

The tire according to clause 6, wherein
a depth of the outer portion is equal to or less than 2.5 mm.

### [Clause 8]

The tire according to any one of clauses 1 to 7, wherein
a pitch length in the tire circumferential direction of the plurality of lateral grooves is smaller than a width in the tire axial direction of the inboard shoulder land portion.

### [Clause 9]

The tire according to clause 8, wherein
the pitch length is in a range of from 70% to 95% of the width of the inboard shoulder land portion.

### [Clause 10]

The tire according to any one of clauses 1 to 9, wherein
the plurality of lateral grooves comprises middle groove portions arranged on the inboard middle land portion, and
at least one of the middle groove portions is provided with a tie-bar in which a bottom thereof is locally raised.

### [Clause 11]

The tire according to any one of clauses 1 to 10, wherein
the inboard middle land portion is provided with a plurality of first middle sipes extending in the tire axial direction from the inboard shoulder circumferential groove and terminating within the inboard middle land portion, and
a plurality of second middle sipes extending in the tire axial direction from the inboard crown circumferential groove and terminating within the inboard middle land portion, and
a total number of the plurality of second middle sipes is greater than a total number of the plurality of first middle sipes.

### [Clause 12]

The tire according to any one of clauses 1 to 11, wherein
the plurality of lateral grooves comprises shoulder groove portions arranged on the inboard shoulder land portion, middle groove portions arranged on the inboard middle land portion, and crown groove portions arranged on the crown land portion,
virtual regions that extend from the respective shoulder groove portions along a length direction thereof toward the tire equator overlap with 50% or more of groove widths at ends of the respective middle groove portions on the inboard tread edge side, and
virtual regions that extend from the respective middle groove portions along a length direction thereof toward the tire equator overlap with 50% or more of groove widths at ends of the respective crown groove portions on the inboard tread edge side.

### [Clause 13]

The tire according to any one of clauses 1 to 12, wherein
the plurality of lateral groove comprises crown groove portions arranged on the crown land portion, and
a length in the tire axial direction of the crown groove portions is in a range of from 60% to 90% of a width in the tire axial direction of the crown land portion.

### [Clause 14]

The tire according to any one of clauses 1 to 13, wherein
the plurality of lateral groove comprises shoulder groove portions arranged on the inboard shoulder land portion,
the shoulder groove portions each comprise a minimum portion where a groove width of the shoulder groove portion is a minimum between a ground contact surface of the inboard shoulder land portion and a bottom of the shoulder groove portion.

### [Clause 15]

The tire according to any one of clauses 1 to 14, wherein
the plurality of lateral grooves comprises middle groove portions arranged on the inboard middle land portion,
each middle groove portion comprises a first portion and a second portion being provided with a tie-bar in which a bottom thereof is locally raised, and
a boundary between the first portion and the second portion is located in a central region when each middle groove portion is divided into three equal parts in the tire axial direction.

### [Clause 16]

The tire according to clause 15, wherein
the second portion is provided with a groove bottom sipe that opens on an outer surface of the tie-bar.

### [Clause 17]

The tire according to clause 16, wherein
a total depth from a ground contact surface of the inboard shoulder land portion to a bottom of the groove bottom sipe is in a range of from 80% to 120% of a depth of the first portion.

### [Clause 18]

The tire according to any one of clauses 1 to 17, wherein
the plurality of lateral grooves comprises crown groove portions arranged on the crown land portion,
the at least one crown sipe comprises a plurality of first crown sipes extending from the inboard crown circumferential groove and a plurality of second crown sipes extending from the outboard crown circumferential groove,
a length in the tire axial direction of the plurality of first crown sipes is smaller than a length in the tire axial direction of the crown groove portions and is equal to or greater than a length in the tire axial direction of the plurality of second crown sipes, and
the crown groove portions each comprises an outer portion opening to a ground contact surface of the crown land portion having a width greater than 1.5 mm, and a sipe portion having a width equal to or less than 1.5 mm and extending inwardly from a bottom of the outer portion.

### [Clause 19]

The tire according to any one of clauses 1 to 18, wherein
the plurality of lateral grooves comprises crown groove portions arranged on the crown land portion,
the at least one crown sipe comprises a plurality of first crown sipes extending from the inboard crown circumferential groove and a plurality of second crown sipes extending from the outboard crown circumferential groove,
a length in the tire axial direction of the plurality of first crown sipes is smaller than a length in the tire axial direction of the crown groove portions and is equal to or greater than a length in the tire axial direction of the plurality of second crown sipes, and
a pitch length in the tire circumferential direction of the plurality of lateral grooves is smaller than a width in the tire axial direction of the inboard shoulder land portion.

### [Clause 20]

The tire according to any one of clauses 1 to 19, wherein
the plurality of lateral grooves comprises crown groove portions arranged on the crown land portion and middle groove portions arranged on the inboard middle land portion,
the at least one crown sipe comprises a plurality of first crown sipes extending from the inboard crown circumferential groove and a plurality of second crown sipes extending from the outboard crown circumferential groove,
a length in the tire axial direction of the plurality of first crown sipes is smaller than a length in the tire axial direction of the crown groove portions and is equal to or greater than a length in the tire axial direction of the plurality of second crown sipes, and
at least one of the middle groove portions is provided with a tie-bar in which a bottom thereof is locally raised.

1. A tire comprising:
a tread portion having a designated mounting direction to a vehicle, the tread portion comprising:
an outboard tread edge located outside of a vehicle when mounted on the vehicle;
an inboard tread edge located inside of a vehicle when mounted on the vehicle;
four circumferential grooves extending continuously in a tire circumferential direction between the outboard tread edge and the inboard tread edge, the four circumferential grooves comprising
an inboard shoulder circumferential groove adjacent to the inboard tread edge,
an inboard crown circumferential groove arranged between the inboard shoulder circumferential groove and a tire equator, and
an outboard crown circumferential groove adjacent to the inboard crown circumferential groove such that the tire equator is located between the outboard crown circumferential groove and the inboard crown circumferential groove;
five land portions divided by the four circumferential grooves, the five land portions comprising
an inboard shoulder land portion including the inboard tread edge,
an inboard middle land portion between the inboard shoulder circumferential groove and the inboard crown circumferential groove, and
a crown land portion between the inboard crown circumferential groove and the outboard crown circumferential groove; and
a plurality of lateral grooves extending at least from the inboard tread edge to the crown land portion and terminating within the crown land portion,
wherein
the crown land portion is provided with at least one crown sipe extending from the inboard crown circumferential groove or the outboard crown circumferential groove and terminating within the crown land portion, and
the at least one crown sipe crosses a center position in a tire axial direction of the crown land portion.

2. The tire according to claim 1, wherein
the plurality of lateral grooves comprises crown groove portions arranged on the crown land portion,
the at least one crown sipe comprises a plurality of first crown sipes extending from the inboard crown circumferential groove, and
a length in the tire axial direction of the plurality of first crown sipes is smaller than a length in the tire axial direction of the crown groove portions.

3. The tire according to claim 2, wherein
the at least one crown sipe comprises a plurality of second crown sipes extending from the outboard crown circumferential groove, and
the length in the tire axial direction of the plurality of first crown sipes is equal to or greater than a length in the tire axial direction of the plurality of second crown sipes.

4. The tire according to claim 3, wherein
the plurality of first crown sipes and the plurality of second crown sipes are arranged alternately in the tire circumferential direction.

5. The tire according to claim 3, wherein
a total number of the plurality of second crown sipes is equal to or less than a total number of the plurality of first crown sipes.

6. The tire according to claim 1, wherein
the plurality of lateral grooves comprises crown groove portions arranged on the crown land portion,
the crown groove portions each comprises an outer portion opening to a ground contact surface of the crown land portion having a width greater than 1.5 mm, and a sipe portion having a width equal to or less than 1.5 mm and extending inwardly from a bottom of the outer portion.

7. The tire according to claim 6, wherein
a depth of the outer portion is equal to or less than 2.5 mm.

8. The tire according to claim 1, wherein
a pitch length in the tire circumferential direction of the plurality of lateral grooves is smaller than a width in the tire axial direction of the inboard shoulder land portion.

9. The tire according to claim 8, wherein
the pitch length is in a range of from 70% to 95% of the width of the inboard shoulder land portion.

10. The tire according to claim 1, wherein
the plurality of lateral grooves comprises middle groove portions arranged on the inboard middle land portion, and
at least one of the middle groove portions is provided with a tie-bar in which a bottom thereof is locally raised.

11. The tire according to claim 1, wherein
the inboard middle land portion is provided with a plurality of first middle sipes extending in the tire axial direction from the inboard shoulder circumferential groove and terminating within the inboard middle land portion, and
a plurality of second middle sipes extending in the tire axial direction from the inboard crown circumferential groove and terminating within the inboard middle land portion, and
a total number of the plurality of second middle sipes is greater than a total number of the plurality of first middle sipes.

12. The tire according to claim 1, wherein
the plurality of lateral grooves comprises shoulder groove portions arranged on the inboard shoulder land portion, middle groove portions arranged on the inboard middle land portion, and crown groove portions arranged on the crown land portion,
virtual regions that extend from the respective shoulder groove portions along a length direction thereof toward the tire equator overlap with 50% or more of groove widths at ends of the respective middle groove portions on the inboard tread edge side, and
virtual regions that extend from the respective middle groove portions along a length direction thereof toward the tire equator overlap with 50% or more of groove widths at ends of the respective crown groove portions on the inboard tread edge side.

13. The tire according to claim 1, wherein
the plurality of lateral groove comprises crown groove portions arranged on the crown land portion, and
a length in the tire axial direction of the crown groove portions is in a range of from 60% to 90% of a width in the tire axial direction of the crown land portion.

14. The tire according to claim 1, wherein
the plurality of lateral groove comprises shoulder groove portions arranged on the inboard shoulder land portion,
the shoulder groove portions each comprise a minimum portion where a groove width of the shoulder groove portion is a minimum between a ground contact surface of the inboard shoulder land portion and a bottom of the shoulder groove portion.

15. The tire according to claim 1, wherein
the plurality of lateral grooves comprises middle groove portions arranged on the inboard middle land portion,
each middle groove portion comprises a first portion and a second portion being provided with a tie-bar in which a bottom thereof is locally raised, and
a boundary between the first portion and the second portion is located in a central region when each middle groove portion is divided into three equal parts in the tire axial direction.

16. The tire according to claim 15, wherein
the second portion is provided with a groove bottom sipe that opens on an outer surface of the tie-bar.

17. The tire according to claim 16, wherein
a total depth from a ground contact surface of the inboard shoulder land portion to a bottom of the groove bottom sipe is in a range of from 80% to 120% of a depth of the first portion.

18. The tire according to claim 1, wherein
the plurality of lateral grooves comprises crown groove portions arranged on the crown land portion,
the at least one crown sipe comprises a plurality of first crown sipes extending from the inboard crown circumferential groove and a plurality of second crown sipes extending from the outboard crown circumferential groove,
a length in the tire axial direction of the plurality of first crown sipes is smaller than a length in the tire axial direction of the crown groove portions and is equal to or greater than a length in the tire axial direction of the plurality of second crown sipes, and
the crown groove portions each comprises an outer portion opening to a ground contact surface of the crown land portion having a width greater than 1.5 mm, and a sipe portion having a width equal to or less than 1.5 mm and extending inwardly from a bottom of the outer portion.

19. The tire according to claim 1, wherein
the plurality of lateral grooves comprises crown groove portions arranged on the crown land portion,
the at least one crown sipe comprises a plurality of first crown sipes extending from the inboard crown circumferential groove and a plurality of second crown sipes extending from the outboard crown circumferential groove,
a length in the tire axial direction of the plurality of first crown sipes is smaller than a length in the tire axial direction of the crown groove portions and is equal to or greater than a length in the tire axial direction of the plurality of second crown sipes, and
a pitch length in the tire circumferential direction of the plurality of lateral grooves is smaller than a width in the tire axial direction of the inboard shoulder land portion.

20. The tire according to claim 1, wherein
the plurality of lateral grooves comprises crown groove portions arranged on the crown land portion and middle groove portions arranged on the inboard middle land portion,
the at least one crown sipe comprises a plurality of first crown sipes extending from the inboard crown circumferential groove and a plurality of second crown sipes extending from the outboard crown circumferential groove,
a length in the tire axial direction of the plurality of first crown sipes is smaller than a length in the tire axial direction of the crown groove portions and is equal to or greater than a length in the tire axial direction of the plurality of second crown sipes, and
at least one of the middle groove portions is provided with a tie-bar in which a bottom thereof is locally raised.
